(19) United States
(12) Patent Application Publication
(10) Pub. No.: US 2018/0249196 A1
(43) Pub. Date: Aug. 30, 2018

(54) SELECTABLE STORAGE OF PUBLIC SAFETY RECORDINGS

(71) Applicant: L3 TECHNOLOGIES, INC., New York, NY (US)

(72) Inventor: Kurt KESSEL, Altamonte Springs, FL (US)

(73) Assignee: L3 TECHNOLOGIES, INC., New York, NY (US)

(21) Appl. No.: 15/906,591

(22) Filed: Feb. 27, 2018

Related U.S. Application Data
(60) Provisional application No. 62/464,103, filed on Feb. 27, 2017.

(51) Int. Cl. H04N 21/274

(52) U.S. Cl. CPC H04N 21/274

(57) ABSTRACT

A management application (cloud-based or on-premise) to allow individuals and organizations to manage their recording devices and where the public safety video recordings are stored, i.e., either on-premise or in the cloud. When the video is downloaded, the system stores the video in a selected location based on one or more options/management criteria.

### CROSS-REFERENCE TO RELATED APPLICATIONS

This application claims the priority benefit of U.S. Provisional Patent Application Ser. No. 62/464,103 filed Feb. 27, 2017, the entirety of which is hereby incorporated by reference herein.

### TECHNICAL FIELD

The present invention relates to mobile and/or portable recording or sensing devices and in particular to user-selectable storage location of such recordings.

### BACKGROUND OF THE INVENTION

Today and in the future public safety practitioners are storing more and more data. The bulk of this data is video data. Current data management programs (techniques) store the video either locally (on-premise) or in the so-called “cloud”. However, known data management technologies for public safety recordings store such recordings in one location or the other, but not both or both at the same time. Some of this recording data can be extraordinarily sensitive such that persons and organizations responsible for protecting such recordings from view are loath to allow it to leave their on-site servers and be placed in the cloud. In other circumstances, such persons and organizations prefer to manage how much data gets stored in the cloud versus locally in order to manage (limit) cloud storage costs.

Thus, it can be seen that there is a need to allow those responsible for storing public safety recordings to manage storage between the cloud and locally on-premise. It is to the provision of such that the present invention is primarily directed.

This feature is available to either an on-premise application or a cloud-based application.

### SUMMARY OF THE INVENTION

Briefly described, the invention relates generally to a management application (cloud-based or on-premise) to allow individuals and organizations to manage their recording devices and where the video recordings are stored, i.e., either on-premise or in the cloud. When the video is downloaded, the system will store the video based on one or more options/management criteria. These options/criteria can include:

Storage location (cloud or on-premise) by device type (e.g., body-worn or in-car);
Storage location by specific device (e.g., serial number);
Storage location by specific device firmware version;
Storage location by date/time the video was downloaded;
Storage location by video meta-data (e.g., category, GPS location, duration, video date/time, officer, etc.);
Storage location by upload point (e.g., office, library, etc.);
Storage location by user group (e.g., traffic officers, patrol officers, etc.); and
Storage location by transmission type (e.g., Ethernet, Wi-Fi, etc.).

Defined another way, the present invention can comprise a method of managing public safety video recordings. The method can include evaluating a management criteria and storing a public safety video recording in a cloud-based electronic storage facility or in an electronic local storage facility based on the evaluated management criteria.

The application (software) can be implemented in various platforms in various ways. For example, the application can be implemented in portable handheld communication devices, like cellular telephones. Also, it can be implemented in tablets, laptops, and other field-deployed electronic equipment. Also, it can be implemented in computer workstations, servers, or the like on-premises. Further, it can be implemented in a cloud-based computing environment for remote access by the users.

Optionally, the video management application can be operative to keep track of the storage location. Thus, when a play request is initiated, the application can stream the video directly or indirectly from where the video is stored to the client requesting the video.

Furthermore, video location selection can be dynamic and not set once for all. In other words, the video location selection can be chosen as the conditions demand. Optionally, changing recording location settings can be implemented in a manner to affect only newly incoming video recordings, and not affect the recording locations of already existing recording files.

Optionally, file metadata can be stored in the application for handy retrieval. The file metadata can also be stored with the file for historical purposes.

While video recordings are the primary focus, the invention is not limited to video, as other large files can also be stored this way (e.g., audio files).

### BRIEF DESCRIPTION OF THE DRAWINGS

FIG. 1 is a schematic, functional diagram depicting a method and apparatus for managing public safety video recordings according to a first preferred example embodiment of the present invention.

### DETAILED DESCRIPTION OF EXAMPLE EMBODIMENTS

The invention relates generally to a management application (cloud-based or on-premise) to allow individuals and organizations to manage their recording devices and where the video recordings are stored, i.e., either on-premise or in the cloud. When the video is downloaded, the system will store the video based on one or more options/management criteria. These options/management criteria can include:

Storage location (cloud or on-premise) by device type (e.g., body-worn or in-car);
Storage location by specific device (e.g., serial number);
Storage location by specific device firmware version;
Storage location by date/time the video was downloaded;
Storage location by video meta-data (e.g., category, GPS location, duration, video date/time, officer, etc.);
Storage location by upload point (e.g., office, library, etc.);
Storage location by user group (e.g., traffic officers, patrol officers, etc.); and
Storage location by transmission type (e.g., Ethernet, Wi-Fi, etc.).

Of course, those skilled in the art will appreciate that the above list of management criteria is not exhaustive and that other management criteria can be used to decide whether to store the public safety video recording locally or in the cloud.

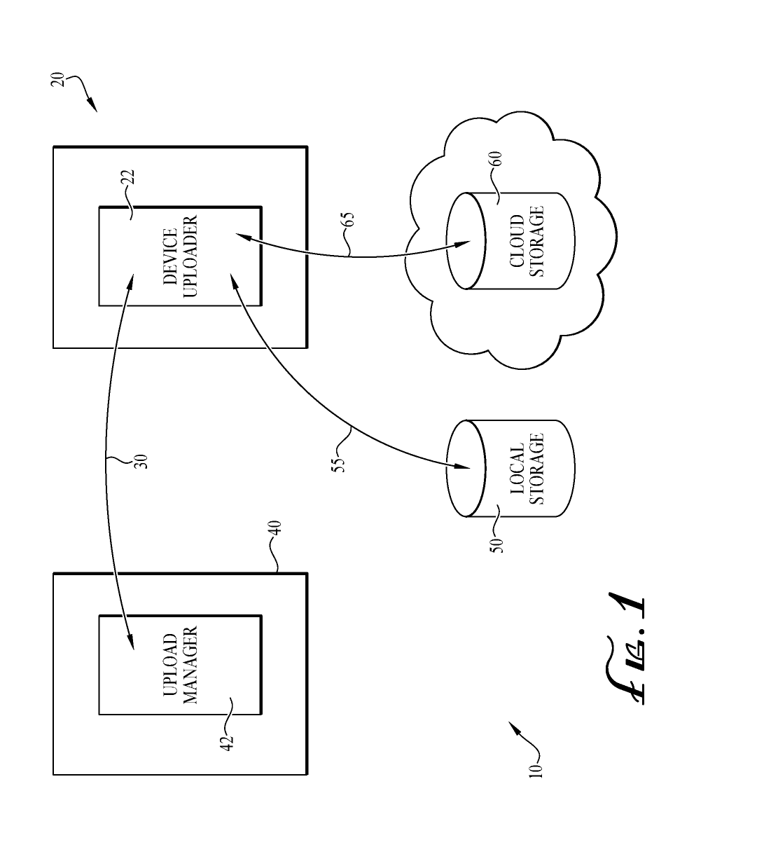

As seen in FIG. 1, an apparatus and system 10 is shown for managing public safety video recordings. The apparatus and system 10 is adapted for evaluating a management criteria and storing a public safety video recording in a cloud-based electronic storage facility or in an electronic local storage facility based on the evaluated management criteria. As shown, a Camera with Video Recorder 20 includes a Device Uploader 22 is adapted to open a communications channel 30 to an Upload Manager 42 of an Application 40 (based on a local processor or in the cloud) and information can be passed between the Device Uploader 22 and the Upload Manager 42. This information will determine where the video is stored based on how the client sets up their application choices. The contemplated criteria can include:

when the public safety video recording is downloaded;
the type of device that made the public safety video recording;
the specific device that made the public safety video recording;
the version of firmware in the specific device that made the public safety video recording;
a date/time associated with the public safety video recording;
the date and time the public safety video recording was created;
the date and time the public safety video recording was forwarded or downloaded for storage;
video meta-data;
upload location point;
user group data, including information about the role of the public safety officer who took the public safety video recording, for example whether the public safety officer is a traffic officer, patrol officer, etc.; and
the transmission type relating to how the public safety video recording is being transmitted.

The Upload Manager 42 is operative to instruct the Device Uploader 22 where and how to upload the files stored on the recording device. The Device Uploader 22 operates to either transmit the file to the on-premise (local) storage 50 or to the cloud storage 60 through the appropriate communications channels 55 or 65.

The application (software) can be implemented in various platforms in various ways. For example, the application can be implemented in portable handheld communication devices, like cellular telephones. Also, it can be implemented in tablets, laptops, and other field-deployed electronic equipment. Also, it can be implemented in computer workstations, servers, or the like locally/on premises. Further, it can be implemented in a cloud-based computing environment for remote access by the users.

Optionally, the video management application can be operative to keep track of the storage location. Thus, when a play request is initiated, the application can stream the video directly or indirectly from where the video is stored to the client requesting the video.

Furthermore, video location selection can be dynamic and not set once for all. In other words, the video location selection can be chosen as the conditions demand. Optionally, changing recording location settings can be implemented in a manner to affect only newly incoming video recordings, and not affect the recording locations of already existing recording files.

Optionally, file metadata can be stored in the application for handy retrieval. The file metadata can also be stored with the file for historical purposes.

A server can be configured to utilize the selectable storage system of the present invention. Such a server can include, but is not limited to, PCs, workstations, laptops, PDAs, palm devices, and the like.

Generally, in terms of hardware architecture, the server includes a processor, a computer readable medium such as memory, and one or more input and/or output (I/O) devices (or peripherals) that are communicatively coupled via a local interface. For example, the local interface can be, but is not limited to, one or more buses or other wired or wireless connections as is known in the art. The local interface may have additional elements, which have been omitted for simplicity, such as controllers, buffers (caches), drivers, repeaters, and receivers, to enable communications. Further, the local interface may include address, control, and/or data connections to enable appropriate communications among the aforementioned components.

The processor is a hardware device for executing software that can be stored in memory. The processor can be virtually any custom made or commercially available processor, a central processing unit (CPU), data signal processor (DSP) or an auxiliary processor among several processors associated with the server, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory can include any one or a combination of volatile memory elements. For example, random access memory (RAM), dynamic random access memory (DRAM), static random access memory (SRAM), or nonvolatile memory elements (e.g., ROM, programmable read only memory (PROM), erasable programmable read only memory (EPROM), electronically erasable programmable read only memory (EEPROM), tape, compact disc read only memory (CD-ROM), disk, diskette, cartridge, cassette or the like). Moreover, the memory may incorporate electronic, magnetic, optical, and/or other types of storage media. Note that the memory can have a distributed architecture, where various components are situated remote from one another, but can be accessed by the processor.

The software in memory may include one or more separate programs, each of which comprises an ordered listing of executable instructions for implementing logical functions. In the example, the software in the memory includes a suitable operating system (O/S) and the selectable storage system of the present invention. As illustrated, the selectable storage system of the present invention comprises numerous functional components.

A non-exhaustive list of examples of suitable commercially available operating systems includes the following: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system essentially controls the execution of other computer programs, such as the selectable storage system, and provides scheduling, input-output control, file and data management, memory management, and communication control and related services. However, it is contemplated by the inventors that the selectable storage system of the present invention is applicable on all other commercially available operating systems.

The selectable storage system may be a source program, executable program (object code), script, or any other entity comprising a set of computer program instructions to be performed. If selectable storage system is embodied in a source program, then the program may be translated via a compiler, assembler, interpreter, or the like, which may or may not be included within the memory, to operate properly in connection with the O/S. Furthermore, the selectable storage system can be written as: (a) an object oriented programming language, which has classes of data and methods; or (b) a procedure programming language, which has routines, subroutines, and/or functions, for example, but not limited to, C, C++, C#, Smalltalk, Pascal, BASIC, API calls, HTML, XHTML, XML, ASP scripts, FORTRAN, COBOL, Perl, Java, ADA, .NET, and the like. The computer program instructions may execute entirely on server, partly on the server, as a stand-alone software package, partly on server and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that can direct a computer, other programmable data processing apparatus, or other devices to function in a particular manner such that the instructions stored in the computer readable medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus.

The I/O devices may include input devices, for example, but not limited to, a mouse, keyboard, scanner (not shown), microphone (not shown), etc. Furthermore, the I/O devices may also include output devices, for example but not limited to, a printer (not shown), display, etc. Finally, the I/O devices may include devices that communicate both inputs and outputs, for example, but not limited to, a NIC or modulator/demodulator (for accessing remote devices, other files, devices, systems, or a network), a radio frequency (RF) or other transceiver (not shown), a telephonic interface (not shown), a bridge (not shown), a router (not shown), etc.

If the server is a PC, workstation, intelligent device or the like, the software in the memory may further include a basic input output system (BIOS) (omitted for simplicity). The BIOS is a set of essential software routines that initialize and test hardware at startup, start the O/S, and support the transfer of data among the hardware devices. The BIOS is stored in some type of read-only-memory, such as ROM, PROM, EPROM, EEPROM or the like, so that the BIOS can be executed when the server is activated.

When the server is in operation, the processor is configured to execute software stored within the memory, to communicate data to and from the memory, and, generally, to control operations of the server are pursuant to the software. The selectable storage system and the O/S are read, in whole or in part, by the processor, perhaps buffered within the processor, and then executed.

When the selectable storage system is implemented in software, it should be noted that the selectable storage system can be embodied in any computer-readable medium for use by, or in connection with, an instruction execution system, apparatus, or device such as a computer-based system, processor-containing system, or other system that can fetch the instructions from the instruction execution system, apparatus, or device and execute the instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the context of this document, a “computer-readable medium” can be any means that can store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a non-exhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

Program code embodied on a computer readable medium may be transmitted using any appropriate medium, including, but not limited to, wireless, wireline, optical fiber cable, RF, etc., or any suitable combination of the foregoing.

In an alternative embodiment, where the selectable storage system is implemented in hardware, the selectable storage system 100 can be implemented with any one or a combination of the following technologies, which are each well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

While video recordings are the primary focus, the invention is not limited to video, as other large files can also be stored this way (e.g., audio files). While the invention has been shown and described in example embodiments, those skilled in the art will appreciate that the invention is not limited to the specific examples described herein and that many additions, deletions, and modifications can be made therein while remaining within the scope and spirit of the invention as set forth in the following claims.

I claim:

1. A method of managing public safety video recordings, the method comprising:
evaluating a management criteria and storing a public safety video recording in a cloud-based electronic storage facility or in an electronic local storage facility based on the evaluated management criteria.

2. The method of claim 1 wherein the management criteria is evaluated when the public safety video recording is downloaded.

3. The method of claim 1 wherein the management criteria comprises the type of device that made the public safety video recording.

4. The method of claim 1 wherein the management criteria comprises the specific device that made the public safety video recording.

5. The method of claim 1 wherein the management criteria comprises the version of firmware in the specific device that made the public safety video recording.

6. The method of claim 1 wherein the management criteria comprises a date/time associated with the public safety video recording.

7. The method of claim 6 wherein the date/time corresponds to the date and time the public safety video recording was created.

8. The method of claim 6 wherein the date/time corresponds to the date and time the public safety video recording was forwarded or downloaded for storage.

9. The method of claim 1 wherein the management criteria comprises video meta-data.

10. The method of claim 1 wherein the management criteria comprises an upload location point.

11. The method of claim 1 wherein the management criteria comprises user group data.

12. The method of claim 11 wherein the user group data includes information about the role of the public safety officer who took the public safety video recording, for example whether the public safety officer is a traffic officer, patrol officer, etc.

13. The method of claim 1 wherein the management criteria comprises a transmission type relating to how the public safety video recording is being transmitted.
